(19) United States
(12) Patent Application Publication
(10) Pub. No.: US 2019/0077910 A1
(43) Pub. Date: Mar. 14, 2019

(54) ELECTRICALLY CONDUCTIVE POLYMER COMPOSITION AND APPLICATION

(71) Applicant: Zeon Chemicals L.P., Louisville, KY (US)

(72) Inventor: Kentaro TSUBATA, Louisville, KY (US)

(21) Appl. No.: 16/185,920

(22) Filed: Nov. 9, 2018

Related U.S. Application Data
(63) Continuation of application No. PCT/US2017/031021, filed on May 4, 2017.
(60) Provisional application No. 62/335,948, filed on May 13, 2016.

(51) Int. Cl. C08G 65/24; C08G 65/30; C08J 3/24; C08L 71/03; C08L 7/00

(52) U.S. Cl. CPC C08G 65/24; C08G 65/30; C08L 7/00; C08L 71/03; C08J 3/24

(57) ABSTRACT

A copolymer comprising about 50 to about 80 mol % alkylene oxide, about 5 to about 50 mol % halo epoxide, and 0 to about 15 mol % diene-epoxide. The copolymer has a water-soluble amount of less than 10 wt %. In some embodiments, the volume resistivity of a semi-conductive composition made from the copolymer is between about 1.0*10⁵ about to 3.5*10⁷ ohms*cm.

### CROSS REFERENCE TO RELATED APPLICATIONS

The present application hereby claims the benefit of the provisional patent application of the same title, Ser. No.62/335,948, filed on May 13, 2016, the disclosure of which is herein incorporated by reference in its entirety.

### BACKGROUND

An electro-photographic system, such as a copier or laser printer uses a conductive roll to charge a photosensitive drum, to supply toner to a photosensitive drum or transfer a toner image to paper. The conductive roll has a semi-conductive composition on the surface.

Generally, conductive rolls are produced by adding carbon black and metal oxide or a conductive agent to rubber or plastic to obtain a satisfactory level of conductivity. However, this method results in a conductive roll that does not produce a sharp image.

### BRIEF SUMMARY

A copolymer comprising about 50 to about 80 mol % alkylene oxide, about 5 to about 50 mol % halo epoxide, and 0 to about 15 mol % diene-epoxide. The copolymer has a water-soluble amount of less than 10 wt %. In some embodiments, the volume resistivity of a semi-conductive composition made from the copolymer is between about 1.0*10⁵ to about 3.5*10⁷ ohms*cm.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is an example OPC test that does not show a defect.

FIG. 2 is an example UPC test that shows a defect.

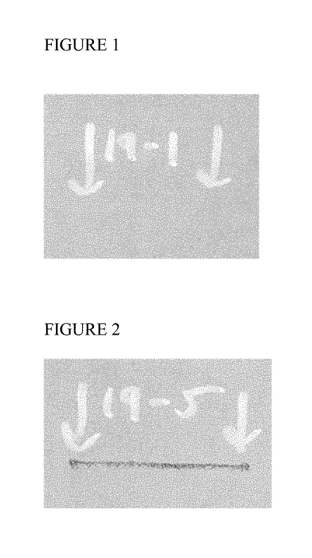

### DETAILED DESCRIPTION

A semi-conductive composition may be used on the surface of a conductive roll in an electrophotographic system. The semi-conductive composition comprises a copolymer that is made from alkylene oxide, halo epoxide, and optionally diene-epoxide monomers. Less than 10 wt % of the semi-conductive composition is water-soluble. In some embodiments, the copolymer is a dimer of alkylene oxide and halo epoxide. In some embodiments, the copolymer is a trimer of alkylene oxide, halo epoxide, and diene-epoxide. In sonic embodiments, the copolymer comprises alkylene oxide and halo epoxide. In some embodiments, the copolymer comprises alkylene oxide, halo epoxide, and diene-epoxide. In some embodiments, the copolymer comprises ethylene oxide and epichlorohydrin. In some embodiments, the copolymer comprises ethylene oxide, epichlorohydrin, and allyl glycidyl ether. In some embodiments, the copolymer is a random copolymer. In some embodiments, the copolymer is a block copolymer.

In some embodiments, the alkylene oxide is selected from ethylene oxide, propylene oxide, 1,2-epoxybutane, 1,2-epoxyisobutene, 2,3-epoxybutane, 1,2-epoxyhexane, 1,2-epoxyoctane, 1,2-epoxydecane, 1,2-epoxytetradecane, 1,2-epoxyhexsadecane, 1,2-epoxyoxtadecane, 1,2-epoxyeicosane; a cyclic alkyl oxide such as 1,2-epoxycyclopentane, -epoxycyclohexane, 1,2-epoxycyclodecane, and mixtures thereof. In some embodiments, the alkylene oxide is ethylene oxide or propylene oxide. In some embodiments, the alkylene oxide is ethylene oxide. In sonic embodiments, the alkylene oxide is propylene oxide. The amount of the alkylene oxide used to make the copolymer is about 50 to about 80 mol %, such as about 51 to about 80 mol about 52 to about 78 mol %, about 54 to about 75 mol %, and 60 to about 74 mol

Examples of halo epoxide include, but are not limited to 4-chloro-1,2-epoxybutane, 4-bromo-1,2-epoxybutane, 1-chloro-3-methyl-2,3-epoxybutane, 1 -bromo-3-methyl-2,3-epoxybutane, epichlorohydrin, epibromohydrin, epiiodehydrin, epifluorohydrin, methallyl chloride epoxide, trifluoromethyl ethylene oxide, perfluoropropylene oxide, perfluoroethylene oxide, vinyl chloride epoxide, dichloroisobutylene epoxide, 1,2-dichloro-3,4-epoxybutane, 1-chloro-3,4-epoxybutane, 1-chloro-4,5-epoxypentane, 1,1-dichloro-2;3-epoxypropane,1,1,1-trichloro-2,3-epoxypropane, 1,1,1-trichloro-3,4-epoxybutane, and mixtures thereof.

In some embodiments, the halo epoxide is an epihalohydrin selected from epichlorohydrin, epibromohydrin, epiiodehydrin, epifluorohydrin, and mixtures thereof. In some embodiments, the epihalohydrin is selected from epichlorohydrin, epibromohydrin, and mixtures thereof. In some embodiments, the epihalohydrin is epichlorohydrin. The amount of the halo epoxide used to make the copolymer is about 5 to about 50 mol %, such as about 15 to about 45 mol %, about 20 to about 40 mol %, about 30 to about 38 mol %, and about 38 to about 40 mol %.

The diene-epoxide is a monomer that comprises a diene and epoxide moiety. In some embodiments, the diene-epoxide is selected from ethylene glycidyl ether, allyl glycidyl ether, vinyl glycidyl ether, butenyl glycidyl ether, o-allyl phenyl glycidyl ether; dienemonoepoxide such as 1,3-butadienemonoepoxide, glycidyl ester such as glycidyl acrylate, glycidyl methacrylate, and mixtures thereof. The diene-epoxide is not required for the copolymer. In some embodiments, the amount of diene-epoxide used to make the copolymer is 0 to about 15 mol %, such as about 2 to about 11 mol %, about 3 to about 11 mol %, about 2 to about 6 mol %, about 3 to about 7 mol %, and about 3 to about 6 mol %.

An example process for making the copolymer comprises the steps of dissolving the alkylene oxide, halo epoxide, and optionally diene-epoxide to form a solution, or mixing them together to form a slurry. The monomers are polymerized to form the copolymer. A description of the ring-opening polymerization process is in JP201132339, and U.S. Pat. No. 3,058,922 (inventor: Edwin J. Vandenberg) the disclosures of which are incorporated by reference in their entirety.

The copolymer is made by ring-opening polymerization. It may be by solution polymerization or slurry polymerization. In some embodiments, the catalyst used in the ring-opening polymerization is an organometallic catalyst, such as an organoaluminum, including trialkyl aluminum, dialkylmonoarylaluminum, monoalkyldiarylaluminutn, and organotin halides with a phosphate. In some embodiments, the organometallic catalyst is selected from trimethyl aluminum, triethylaluminum, triisopropylaluminum, tributylaluminum, bis(2,6-di-tert-butyl-4-methyl-phenolate)methylaluminum, Al(C₆F₅)₃, and (porphyrin)Al complexes. In some embodiments, the organometallic catalyst is selected from tfibutyltin chloride. A description of the catalyst and its use may be found in U.S. Pat. No. 3,135,705, (inventor: Edwin J. Vandenberg), the disclosure of which is incorporated by reference in its entirety.

After polymerization the copolymer is isolated from the solution or slurry, for example by coagulation and filtration. In some embodiments, the copolymer is isolated by steam stripping coagulation which is done at a temperature of about 40 to about 150° C. After the copolymer has been coagulated it is isolated by filtration.

After the copolymer has been isolated, it is processed by cold absorption. Cold absorption is treating the copolymer with a solvent so that the solvent is absorbed into the copolymer. In some embodiments, the copolymer is agitated during or when the copolymer has absorbed the solvent. Examples of agitation include stirring, mixing, shaking, ultrasonic, or other methods know to a person of skill in the art. In some embodiments, the temperature during the absorption process is from about −20° C. to about 40° C., such as about −10° C. to about 40° C., about −10° C. to about 30° C., about 0° C. to about 40° C., about 0° C. to about 30° C., about 10° C. to about 40° C., about 10° C. to about 30° C., about 20° C. to about 40° C., about 20° C. to about 30° C., about −20° C. to about 30° C., about −20° C. to about 20° C., about −20° C. to about 10° C., and about −20° C. to about −10° C. In some embodiments, the absorption is done with a polar solvent. Examples of a polar solvent include, but are not limited to, water, methanol, ethanol, propanol, and isopropanol. In some embodiments, the cold absorption process is done from about 0.5 hours to about 500 hours, such as about 1 to about 100 hours. In some embodiments, additives are added during the absorption process, such as salts or surfactants. After the cold absorption process the copolymer is filtered and the solvent is removed. The filtering and drying process are well known to a person of ordinary skill in the art.

The copolymer is cross-linked to form it into a semi-conductive composition. The copolymer is compounded by mixing a cross-linking agent and accelerator to the copolymer. Cross-linking agents include, but are not limited to, polyamine, thiourea, thiadiazole, triazine, quinoxalin acid, bisphenol, organic peroxide, sulfur, thiuram, morpholine sulfide, and mixtures thereof. In sonic embodiments, the amount of cross-linking agent to 100 parts of copolymer by weight, is about 0.1 to about 10 parts, such as about 0.5 to about 5.0. Examples of cross-linking accelerators include, but are not limited to, thiazole, sulfenamide, guanidine, thiourea, and mixtures thereof. The amount of the cross-linking accelerator to 100 parts of copolymer by weight, is about 0.1 to about 10 parts, such as about 0.5 to about 5 parts.

Examples of potyamines include, but are not limited to ethylene di amine, hexamethylene diamine, diethylene triamine, triethylene tetramine, hexamethylene tetramine, p-phenyl diamine, cumene di amine, N,N′-dicinnamylidene-1,6-hexane diamine, ethylene diamine carbamate, and hexamethylene diamine carbamate. Examples of thiourea include, but are not limited to 2-mercaptoimidazoline, 1,3-diethylthiourea, 1,3-dibuthylthiourea, and trimethylthiourea. Examples of thiadiazole include, but are not limited to 2,5-dimercapto-1,3,4-thiadiazole, and 2-mercapto-1,3,4-thiadiazole-5-thiobenzoate. Examples of triazine include, but are not limited to 2,4,6-trimercapto-1,3,5-triazine, 2-methylamino-4,6-dimercaptotriadine, 2-dimethylamino-4,6-dimercaptotriazine, 2-ethylamino-4,6-dimercaptotriazine, 2-diethylamino-4,6-dimercaptotriazine, 2-propylamino-4,6-dimercaptotriazine, 2-dipropylamino-4,6-dimercaptotrizine, 2-butylamino-4,6-dimercapto4,6-dimercaptotriazine, 2-dibutyl amino-4,6-dimercaptotriazine, 2-anilino-4,6-dimercaptotriazine, 2-hexylamino-4,6-dimercaptotriadine, 2-cyclohexylamino-4,6-ditnercaptotriadine, 2-octylatnino-4,6-dimercaptotriadine, 2-morpholyl-4,6-dimerucaptotriazine, and 2-phenylamino-4,6-ditnercaptotriazine. Examples of quinoxaline include, but are not limited to 2,3-dimercaptoquinoxaline, quinoxaline-2,3-dithiocarbonate, 6-methyl quinoxaline-2,3-dithiocarbonate, and 5,8-dimethylquinoxaline-2,3-dithiocarbonate. Examples of bisphenol include, but are not limited to bisphenol AF and bisphenol S. Examples of organic peroxide include, but are not limited to tea-butyl hydroperoxide, p-menthane hydroperoxide, dicumylperoxide, tert-butyl peroxide, 1,3-bis-(2-tert-butylperoxiisopropyl)benzol, 2,5-dimethyl-2,5-di(tert-butylperoxi)hexane, benzoytperoxide, and tert-butylperoxidebenzoate. Examples of sulfur include, but are not limited to powdered sulfur, precipitated sulfur, colloidal sulfur, surface-treated sulfur, and insoluble sulfur. Examples of thiuram include, but are not limited to tetramethylthiuramdisulfide, tetraethylthiuram disulfide, tetrabutylthiuramdisulfide, dipentamethylenethiuramtetrasulfide, dipentameth.ylenethiuramhexasulfide, and tetramethylthiurammonosulfide. Examples of morpholine sulfide include, but are not limited to 4,4′-dithiodimorpholine.

Examples of cross-linking accelerators include, but are not limited to, thiazole, such as a 2-mercaptobenzothiazole salt, such as a zinc salt or cycl ohexyl amine salt; sulfenamide, such as N-cyclohexil-2-benzothiazyl-sulfenamide, N,N-dicyclohexyl benzothiazyl-2-sulfenamide, N,N-dicycl ohexyl-2-benzothi zyl-sulfenamide, N-oxydietylene-2-benzothiazyl-sulfenamide, N-tert-butyl-2-benzothiazyl-sulfenamide, and N-tert-butyl-di(2-benzothiazole)-sulfeneamide, guanidine such as diphenylguanidine and 1,3-di-o-tolylguanidine; thiourea, such as theylenethiourea, diethylthiourea, dibuthylthiourea, dilaurylthiourea, trimethylthiourea, and diphenylthiourea.

In some embodiments, additives are added to the copolymer during compounding. Examples of additives include, but are not limited to, acid acceptors, fillers, cross-linking compounds, plasticizers, processing aids, flame retardants, pigments, anti-oxidants, cross-linking accelerator aids, adhesive agents, ta.ckifiers, surfactants, conductive agents, colorants and other polymers.

loom Examples of acid acceptors include, but are not limited to the alkaline earth metal oxides, hydroxide, carbonate, carboxylate, silicate, borate, phosphite, group fourteen elements, basic carbonate, basic carboxylate, basic phosphite, basic sulfite, tribasic sulfate, magnesium oxide, magnesium hydroxide, magnesium carbonate, barium hydroxide, calcium hydroxide, calcium oxide, calcium carbonate, calcium silicate, stearic acid calcium, stearic acid zinc, phthalic acid calcium salt, phosphorous acid calcium salt, zinc oxide, tin oxide, stearic acid tin salt, basic phosphorous acid tin, and mixtures thereof.

Examples of mineral fillers and acid acceptors include, but are not limited to hydrotalcite such as MgₓAl_{y}(OH)_{(2x+3y-2)}CO₃.wH₂O(x=1-10, y=1-5, w=integer), such as Mg_{4.5}Al₂(OH)CO₃.3.5H₂O, Mg_{4.5}Al₂(OH)₁₃CO₃, Mg₄Al₂(OH)₁₃CO₃.3.5H₂O, Mg₆Al₂(OH)₁₆CO₃.4H₂O, and Mg₅Al₂(OH)₁₄CO₃.4H₂O.

Examples of cross-linking compounds include, but are not limited to unsaturated diene group rubber, such as butadiene rubber, styrene butadiene rubber, chloroprene rubber, isoprene rubber, natural rubber, acrylonitrile butadiene rubber, butyl rubber, and hydrogenated rubber of these polymers; non-diene containing group rubber, such as ethylene propylene rubber, acrylic rubber, polyether rubber, chlorosulfonyl-polyethylene rubber, fluoric rubber, and silicon rubber; thermoplastics, such as olefin thermoplastic elastomer, styrene thermoplastic elastomer, vinyl chloride thermoplastic elastomer, polyester thermoplastic elastomer, polyamide thermoplastic elastomer, and polyurethane thermoplastic elastomer; and resin, such as polyvinylchloride, coumarone resin, phenol resin, and ABS resin.

After the copolymer, cross-linking agent, and any additional additives are compounded, the mixture is cured. The compounded mixture is shaped and then cured with heat to cross-link the copolymer. In some embodiments, the compounded mixture is held at a temperature ranging from about 20° C. to about 200° C. for about 30 seconds to about 300 minutes. During that time it may be compression molded, injection molded, heated in a steam oven, microwave, or radiation. After the copolymer is cured, it is post cured at a temperature ranging from about 20° C. to about 200° C. for about 30 minutes to about 48 hours.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

### Example 1

Epichlorohydrin (893.8 parts ethylene oxide (78.6 parts), allylglycidyl ether (110.1 parts) and of toluene (9219.4 parts) were charged into an autoclave. The mixture was stirred under nitrogen while raising the temperature to 70° C. A trialkylaluminum catalyst system (30 parts) was added to the mixture to start the reaction. A solution of 517.4 parts of ethylene oxide dissolved into 1207.3 parts of toluene and a separate 150 parts of the trialkylalutninum catalyst system were continuously added to the mixture for 5 hours at a constant rate. Water (45 parts) was added to the mixture and stirred. 4,4′-thiobis-(6-tert-butyl-3-methylphenol) (8 parts) was dissolved into 152 parts of toluene was added to the mixture. Steam stripping was done to remove toluene from the mixture. The wet polymer and water were separated by filtration. The wet polymer was immersed in water for 7 hours at 23° C. The wet polymer was separated by filtration then vacuumed dried for 15 hours at 60° C., to obtain 1578.4 parts of polyether polymer 1. The ethylene oxide (EO) mol % was estimated to be 55.7 mol % by Cl content and AGE content. The water-soluble content of copolymer 1 was 0.6 wt %.

Copolymer 1 (100 parts), 1 part of stearic acid, 5 parts of zinc oxide, 1.5 parts of tetratnethylthiurain monosulfide, 2 parts of 4,4′-dithiodimorpholine, and 0.5 parts of sulfur were mixed in a Banbury mixer to obtain the cross-linkable compound 1.

The semi-conductive composition 1 was prepared by pressing and heating the cross-linkable compound 1 at 170° C. for 20 minutes to a 150 mm×150 mm×2 mm thick sheet. Post cure was done in a Geer Oven at 150° C. for 4 hours. The volume resistivity and. OPC crazing of semi-conductive composition 1 was measured.

### Example 2

Epichlorohydrin (794.6 parts), 89.8 parts of ethylene oxide, 115.2 parts of allylglycidyl ether, and 8398.3 parts of toluene were charged into an autoclave. The mixture was stirred under nitrogen while raising the temperature to 70° C. A trialkylaluminum catalyst system (30 parts) was added to the mixture to start the reaction. A solution of 600.3 parts of ethylene oxide dissolved into 1310.9 parts of toluene and a separate 150 parts of the prepared catalyst solution were continuously added to the mixture for 5 hours at a constant rate. Water (45 parts) was added to the mixture and stirred. 4,4′-thiobis-(6-tert-butyl-3-methylphenol) (8 parts) was dissolved into 152 parts of toluene and added to the mixture. Steam stripping was used to remove toluene from the mixture. The wet polymer and water were separated by filtration. The wet polymer was immersed in water for 7 hours at 23° C. The wet polymer was separated by filtration then vacuumed dried for 15 hours at 60° C. to obtain 1567.8 parts of polyether polymer 2. The EO mol % was estimated to be 61.5 mol % by Cl content and AGE content. The water-soluble content of copolymer 2 was 1.1 wt %.

Cross-linkable compound 2 and semi-conductive composition 2 were obtained in the same manner as in Example 1.

### Example 3

Epichlorohydrin (647.3 parts), 106.1 parts of ethylene oxide, 122.7 parts of allylglycidyl ether, and 7168.5 parts of toluene were charged into an autoclave. The mixture was stirred under nitrogen while raising the temperature to 70° C. A trial kylaluminum catalyst system (30 parts) was added to the mixture to start the reaction. A solution of 723.9 parts of ethylene oxide dissolved into 1626.3 parts of toluene and a separate 150 parts of the trial kyl aluminum catalyst system were continuously added to the mixture for 5 hours at a constant rate. Water (4⁵ parts) was added to the mixture and stirred. 4,4′-thiobis-(6-tert-butyl-3-methylphenol) (8 parts) was dissolved into 152 parts of toluene was added to the mixture. Steam stripping removed toluene from the mixture. The wet polymer and water were separated by filtration. The wet polymer was immersed in water for 7 hours at 23° C. The wet polymer was separated by filtration then vacuumed dried for 15 hours at 60° C. to obtain 1560.7 parts of polyether polymer 3. EO mol % was estimated to be 69.6 mol % by Cl content and AGE content. The water-soluble content of copolymer 3 was 1.9 wt %.

Cross-linkable compound 3 and semi-conductive composition 3 were obtained in the same manner as in Example 1.

### Example 4

Polymerization and steam stripping was done in the same manner as in Example 2. The wet polymer and hot water were separated by filtration. The wet polymer was vacuum dried for 15 hours at 60 DC to obtain 1575.3 parts of polyether polymer 4. The EO mol % was estimated to be 61,6 mol % by Cl content and AGE content. The polyether polymer 4 was cut into 10 mm cubes and placed in toluene for 24 hours at 23° C. Steam stripping was done to remove toluene from the mixture, The wet polymer and water were separated by filtration. The wet polymer was immersed in water for 7 hours at 23° C. The wet polymer was separated by filtration then vacuum dried for 15 hours at 60 DC to obtain 1540.3 parts of polyether polymer 4. The EO mol % was estimated to be 61.5 mol % by Cl content and AGE content. The water-soluble content of copolymer 4 was 1.3 wt %.

Cross-linkable compound 4 and semi-conductive composition 4 were Obtained in the same manner as in Example 1.

### Example 5

Polymerization and steam stripping was done in the same manner as in Example 3. The wet polymer and water were separated by filtration. The wet polymer was immersed in water for 7 hours at 5° C. The wet polymer was separated by filtration then vacuum dried for 24 hours at 60° C. to obtain 1512.4 parts of polyether polymer 5. The EO mol % was estimated to be 69.4 mol % by Cl content and AGE content. The water-soluble content of copolymer 5 was 1.7 wt %.

Cross-linkable compound 5 and semi-conductive composition 5 were Obtained in the same manner as in Example 1

### Comparative Example 6

Epichlorohydrin (1013.3 parts), 64.8 parts of ethylene oxide, 104.1 parts of allylglycidyl ether, and 10201.9 parts of toluene were charged into an autoclave. The mixture was stirred under nitrogen while raising the temperature to 70° C. A trialkylaluminum catalyst system (30 parts) was added to the mixture to start the reaction. A solution of 417.8 parts of ethylene oxide dissolved into 938.8 parts of toluene and a separate 150 parts of the trialkylaluminum catalyst system were continuously added to the mixture for 5 hours at a constant rate. Water (45 parts) was added to the mixture and stirred. 4,4′-thiobis-(6-tert-butyl-3-methylphenol) (8 parts) was dissolved into 152 parts of toluene and added to the mixture. Steam stripping removed toluene from the mixture. The wet polymer and water were separated by filtration. The wet polymer was immersed in water for 7 hours at 23° C. The wet polymer was separated by filtration then vacuum dried for 15 hours at 60° C. to obtain 1591.4 parts of polyether polymer 6. The EO mol % was estimated to be 47.9 mol % by Cl content and AGE content. The water-soluble content of copolymer 6 was 0.1 wt %.

Cross-linkable compound 6 and semi-conductive composition 6 were obtained in the same manner as in Example 1.

### Comparative Example 7

Polymerization and was done in the same manner as in Example 3. Daxad 17 (80 parts, manufactured GEO Specialty Chemicals) was added to the polymer solution as a anionic surfactant. Steam stripping removed toluene from the mixture. The wet polymer and hot water were separated by filtration. The wet polymer was vacuumed dried for 15 hours at 60° C. to obtain 1580.8 parts of polyether polymer 7. The EO mol % was estimated to be 69.3 mol % by Cl content and AGE content. The water-soluble content of copolymer 7 was 10.7 wt %.

Cross-linkable compound 7 and semi-conductive composition 7 were obtained in the same manner as in Example I.

### Comparative Example 8

Polyether polymer 8 was obtained in the same manner as in Comparative Example 7, The polyether polymer 8 was cut into lOmm cubes and immersed in water for 24 hours at 23° C. The wet polymer was vacuum dried for 15 hours at 60° C. to obtain 1535.0 parts of polyether polymer 8. The EO mol % was estimated to be 69.2 mol % by Cl content and AGE content. The water-soluble content of copolymer 8 was 10.2 wt %.

Cross-linkable compound 8 and semi-conductive composition 8 were obtained in the same manner as in Example 1.

Example 1 thorough 5 showed good volume resistivity, water-soluble content of polymer, and OPC crazing. Comparative example 7 and 8 showed poor OPC crazing and high water-soluble content. Comparative example 6 showed poor volume resistivity.

TABLE I

| | | | | | Water- | |
|---|---|---|---|---|---|---|
| | | | | | soluble | |
| | | | | | content | |
| | | | | Volume | of | OPC |
| | Cl | AGE | EO | resistivity | polymer | crazing |
| Example | (mol %) | (mol %) | (mol %) | (ohms * cm) | (%) | test |
| Ex1 | 40.3 | 4.0 | 55.7 | 6.1 * 10⁶ | 0.6 | E |
| Ex2 | 34.6 | 3.9 | 61.5 | 4.4 * 10⁶ | 1.1 | E |
| Ex3 | 26.4 | 4.0 | 69.6 | 2.3 * 10⁶ | 1.9 | G |
| Ex4 | 34.6 | 3.9 | 61.5 | 4.0 * 10⁶ | 1.3 | E |
| Ex5 | 26.6 | 4.0 | 69.4 | 2.6 * 10⁶ | 1.7 | E |
| CEx6 | 48.1 | 4.0 | 47.9 | 4.1 * 10⁷ | 0.1 | E |
| CEx7 | 26.7 | 4.0 | 69.3 | 2.7 * 10⁶ | 10.7 | P |
| CEx8 | 26.8 | 4.0 | 69.2 | 2.5 * 10⁶ | 10.2 | P |

E = Excellent,
G = Good,
B = Poor

### Volume Resistivity Measurement

Volume resistivity of the semi-conductive composition is measured using a HIRESTA-UP instrument, manufactured by Mitsubishi Chemical Analytech Co., Ltd. The test is done at 100V for 60 seconds at 23° C. and 50% relative humidity, and the results are calculated based on the resistivity and the thickness of the sample tested. The volume resistivity is measured on the copolymer by first converting it to the semi-conductive composition as described in Example 1.

### Water-Soluble Amount Measurement

The water-soluble amount of the copolymer is measured by measuring the weight of the sample before the test and comparing the weight after the sample is immersed in water for 168 hours at 23° C. then vacuum dried for 24 hours at 60° C. The sample size is 1 gram cut into about 1 mm cubes.

### Organic Photo Conductor (OPC) Crazing Test

The organic photo conductor (OPC) crazing test is conducted by placing the cured rubber sheet in contact with the organic photo conductor for 18 days at 43° C. and 80% relative humidity. The cured rubber is then removed from the OPC surface and used in a C544n Lexmark printer. The OPC was obtained from the toner cartridge of a C544n Lexmark printer. The OPC crazing test prints an image of 10% coverage five times. The result is considered excellent if there are no print quality defects, such as a lighter or darker line, on any of the prints. The result is considered good if there are print quality defects on the first print but no defects on the fifth print. The result is considered poor if all the prints have defects.

1. A copolymer comprising:
about 50 to about 80 mol % alkylene oxide,
about 5 to about 50 mol % halo epoxide, and
0 to about 15 mol % diene-epoxide,
wherein the copolymer comprises has a water-solu amount of less than 10 wt %.

2. The copolymer of claim 1, wherein composition comprises a water-soluble amount of less than 5 wt %.

3. The copolymer of clam 1, wherein the composition comprises a water-soluble amount of less than 2 wt %.

4. The copolymer of claim 1, wherein a semi-conductive composition formed from the copolymer has a volume resistivity of between about 1.0*10⁵ to 3.5*10⁷ ohms*cm.

5. The copolymer of claim 1, wherein the alkylene oxide is selected from ethylene oxide, propylene oxide, and mixtures thereof.

6. The copolymer of claim 1, wherein the halo epoxide is an epihalohydrin.

7. The copolymer of claim 6, wherein the epihalohydrin is epichlorohydrin.

8. A semi-conductive composition comprising the cured copolymer of claim 1.

9. The semi-conductive composition of claim 8, wherein the composition additionally comprises NBR.

10. A method for purifying a copolymer, comprising the steps of:
providing a copolymer, wherein the copolymer comprises:
about 50 to about 80 mol % alkylene oxide,
about 5 to about 50 mol % halo epoxide, and
0 to about 15 mol % diene-epoxide,
processing the copolymer by cold absorption comprising mixing the copolymer with a solvent, wherein the solvent is at a temperature from about −20° C. to about 40° C., then
removing the solvent from the copolymer.

11. The method of claim 10, wherein the solvent is selected from water, methanol, ethanol, propanol, and isopropanol.

12. The method of claim 10, wherein the copolymer has a water-soluble amount of less than 10 wt %

13. A method for making a semi-conductive composition comprising the steps of:
claim 10,
compounding the copolymer with a cross-linking agent and accelerator, and
curing the compounded mixture to a semi-conductive composition.

14. The method of claim 10, wherein the semi-conductive composition has a volume resistivity of between about 1.0*10⁵ to about 3.5*10⁷ ohms*cm.
